(19) United States
(12) Patent Application Publication
(10) Pub. No.: US 2018/0101801 A1
(43) Pub. Date: Apr. 12, 2018

(54) ARCHITECTURE, SYSTEM AND METHOD FOR COORDINATING SERVICE REQUESTS FROM SERVICE REQUESTORS TO PROVIDERS

(71) Applicant: Statim Corp., Chula Vista, CA (US)

(72) Inventors: Victor Manuel Renteria, JR., Bonita, CA (US); Roberto Gregorio Velasco, Lemon Grove, CA (US)

(21) Appl. No.: 15/730,295

(22) Filed: Oct. 11, 2017

Related U.S. Application Data
(60) Provisional application No. 62/496,185, filed on Oct. 11, 2016.

(51) Int. Cl. G06Q 10/06; G06Q 10/10; G06Q 30/04; H04L 29/08; H04W 4/02; H04W 4/12; G06F 9/44

(52) U.S. Cl. CPC G06Q 10/06311; G06Q 10/06314; G06Q 10/1097; G06F 9/4443; H04L 67/18; H04W 4/02; H04W 4/12; G06Q 30/04

(57) ABSTRACT

Embodiments of architecture to enable a 3^{rd} party to locate or engage one or more service providers to perform services at particular location within a certain time frame, providing a benefit to the service requestor (party) and service providers. Other embodiments may be described and claimed.

### TECHNICAL FIELD

Various embodiments described herein relate generally to dispatching or coordinating service requests from service requestors to service providers.

### BACKGROUND INFORMATION

A party may require or desire that one or more services be performed at one or more locations. A party may attempt to contact one or more service providers that have the requisite skills or experience to perform the one or more services at the one or more locations. The party may also employ a 3^{rd} party or agency to attempt to locate one or more service providers that have the requisite skills or experience to perform the one or more services at the one or more locations. The party may require or need the services to be performed within a predetermined time period. A 3^{rd} party may not have sufficient access or resources to locate service providers to perform services at a particular location within a certain time frame. The present invention provides an architecture to enable a 3^{rd} party to locate or engage one or more service providers to perform services at particular location within a certain time frame, providing a benefit to the service requestor (party) and service providers.

### BRIEF DESCRIPTION OF THE DRAWINGS

FIG. 1 is a block diagram of service request processing architecture according to various embodiments.

FIG. 2A is a diagram of communication between a first service requestor device and a service activity processing system in a service request processing architecture according to various embodiments.

FIG. 2B is a diagram of communication between a first service provider device and a service activity processing system in a service request processing architecture according to various embodiments.

FIG. 2C is a diagram of communication between a first service requestor device, a service activity processing system, and a first service provider device in a service request processing architecture according to various embodiments.

FIG. 2D is a diagram of communication between a first service requestor device, a service activity processing system, and a first service provider device in a service request processing architecture according to various embodiments.

FIG. 2E is a diagram of communication between a first service requestor device, a service activity processing system, and a first service provider device in a service request processing architecture according to various embodiments.

FIG. 3A is a block diagram of a service request processing system showing a service activity processing system communicating a services available display to a service requestor device according to various embodiments.

FIG. 3B is a block diagram of a service request processing system showing a service activity processing system communicating a service request display to a service requestor device according to various embodiments.

FIG. 3C is a block diagram of a service request processing system showing a service activity processing system communicating a service award display to a service requestor device according to various embodiments.

FIG. 3D is a block diagram of a service request processing system showing a service activity processing system communicating a services offered display to a service provider device according to various embodiments.

FIG. 3E is a block diagram of a service request processing system showing a service activity processing system communicating a service proposal display to a service provider device according to various embodiments.

FIG. 3F is a block diagram of a service request processing system showing a service activity processing system communicating a service award display to a service provider device according to various embodiments.

FIG. 4 is a block diagram of a service activity processing system according to various embodiments.

FIG. 5 is a flow diagram illustrating several methods for a service activity processing system according to various embodiments.

FIG. 6A is a block diagram of an article according to various embodiments.

FIG. 6B is a block diagram of an article according to various embodiments.

### DETAILED DESCRIPTION

A party (service requestor) may need professional or personal services performed at a location within a certain time frame. A person (service provider) that provides certain professional or personal services may wish to be engaged to provide such services. The service requestor may need specific services where the service provider has certain certified skills. A service provider may wish to provide services based on their skill set. For a service requestor the services may need to be provided within a short time frame (short call out). Similarly, a service provider may wish to be engaged on a project versus waiting for a project.

The present invention provides architecture 50 termed a service request processing architecture 50 that includes a service activity processing system SAPS 40, service provider devices 12A-C, and service requestor devices 22A-C that may be coupled to the SAPS 40 via various networks 10A, 10B, and 30. In an embodiment, a service requestor 56 may employ a service requestor device 22A-C to generate and forward a request for services including the type of service(s), location(s), and time(s), termed a SLT request 27 to the SAPS 40. A service provider 62 via a service provider device 12A-C may register with the SAPS 40 and indicate when they are available to perform certain services.

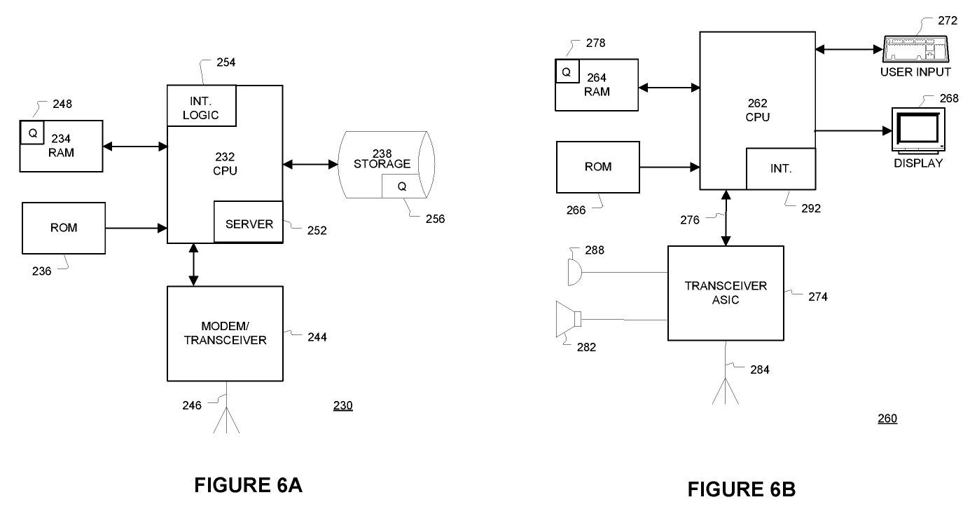

The devices 12A-C and 22A-C may be any electronic device including a communication interface 14A-C, 24A-C and user interface (to be notified of data and response). The devices 12A-C and 22A-C may be mobile devices and local devices including mobile telephones, laptops, tablets, personal data assistants, and intelligent speaker interfaces such as Alexia™ that enable a user to receive notice of an service related event and respond. A SAPS 40 may be any electronic device including a communication interface or server 42 and processor (232—FIG. 6A) that may process service events and communicate data between devices 12A-C and 22A-C in various networks 10A, 10B, and 30. Service request processing architecture 50 may also include a plurality of SAPS 40 at different locations or similar locations to provide redundant or independent service processing in an embodiment.

In an embodiment, once a SAPS 40 receives a SLT request 27, it may determine which available service providers 62 may be able to perform the SLT request 27. The SAPS 40 may inform one or more service providers 62 of the possible SLT project by forwarding or providing a SLT proposal to the service providers 62 devices 12A-C. A service provider 62 interested in performing the SLT request 27 may send a SLT proposal interest response to the SAPS 40 via their device 12A-C. A SAPS 40 may then determine which service provider 62 to receive or perform the SLT request 27 based on various factors including their location, rating, and service experience. The SAPS 40 may inform a service provider 62 of the project assignment or grant by sending a SLT award message to their device 12A-C.

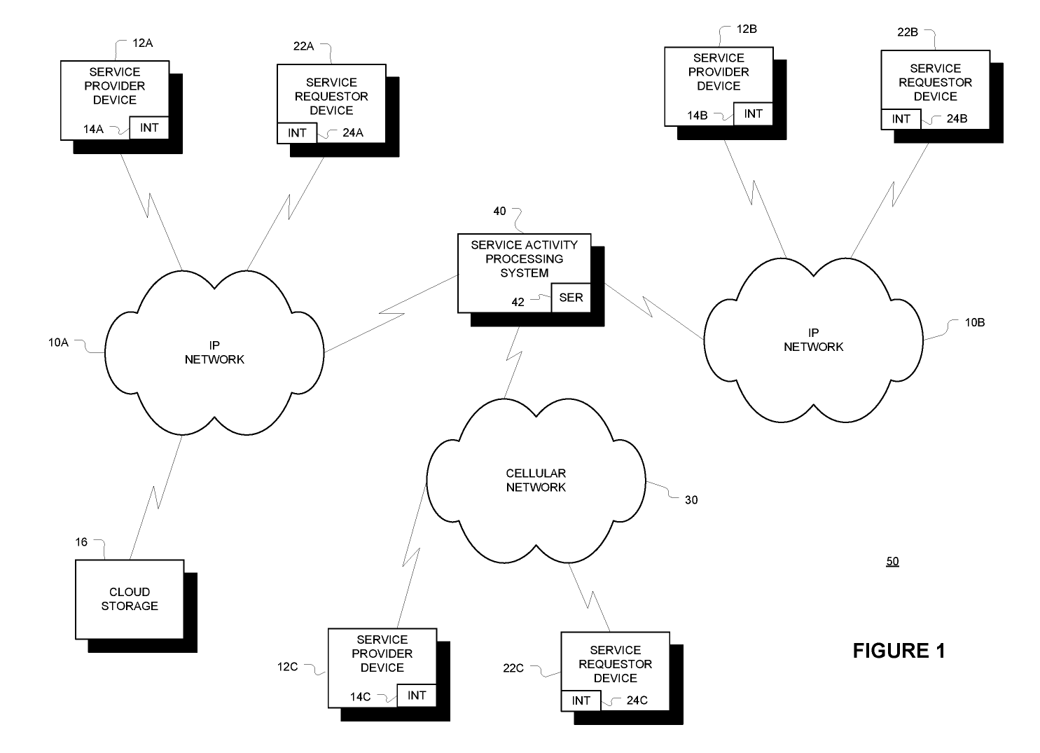

FIG. 1 is a block diagram of service request processing architecture 50 according to various embodiments comprising a service activity processing system (SAPS) 40, several service provider devices (SPD) 12A-12C, several service requestor devices (SRD) 22A-22C, cloud storage 16, and one or more networks 10A, 10B, 30. In an embodiment, a service requestor's SRD 22A-22C, a service provider's SPD 12A-12C, and cloud storage 16 may be coupled to the SAPS 40 via a wired or wireless IP network 10A, 10B, cellular network 30, combination thereof, or other networks. An IP network 10A or 10B may be a local network, a network of networks, or a worldwide network of networks, termed the “Internet”.

The cellular network 30 may be a terrestrially based network, satellite based network, or combination thereof. A SPD 12A-12C and SRD 22A-22C may include an interface module 14A-14C, 24A-24C that may be able to communicate over a cellular network 30 and an IP network 10A, 10B in an embodiment. A service requestor 56 and service provider 62 may be required to register with a SAPS 40 to participate in service request processing architecture 50 via a device 12A-12C, 22A-22C. As part of the registration, a service requestor 56 via a SRD 22A-22C may also indicate service they may want to request. Similarly, a service provider 62 via a SPD 12A-12C may include the services they can provide.

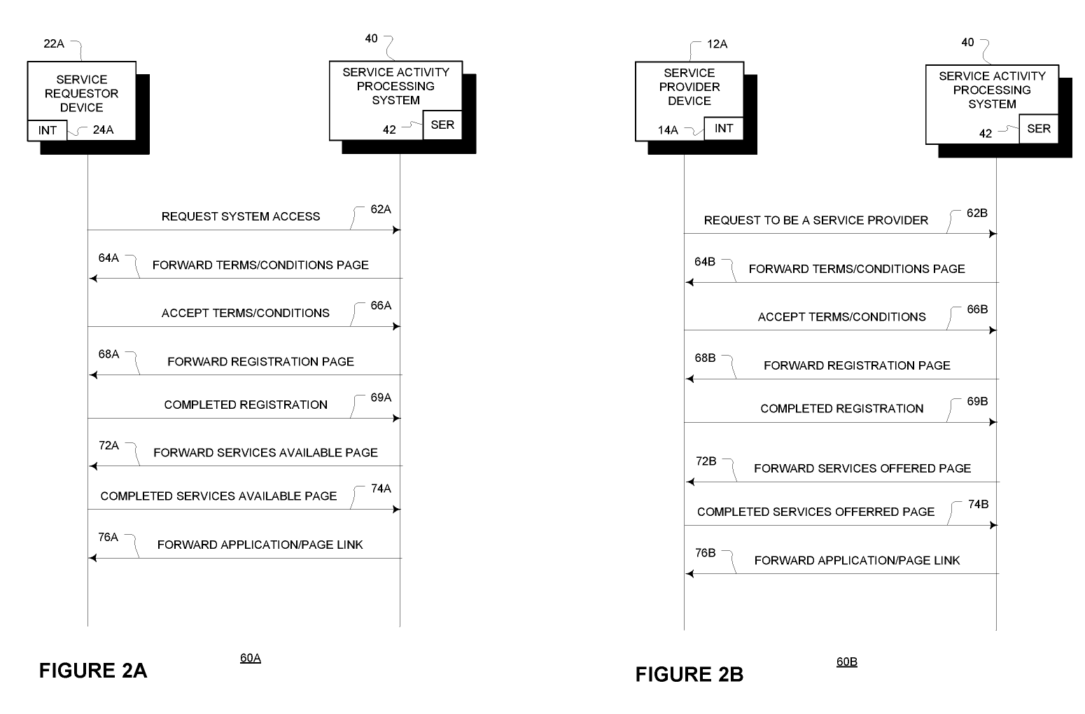

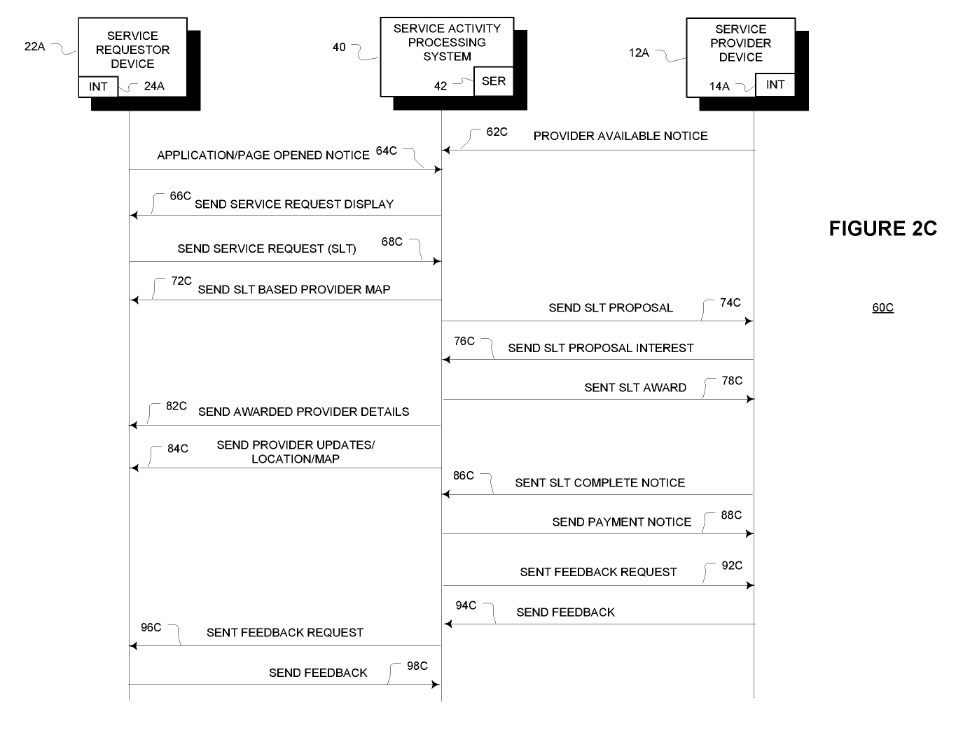

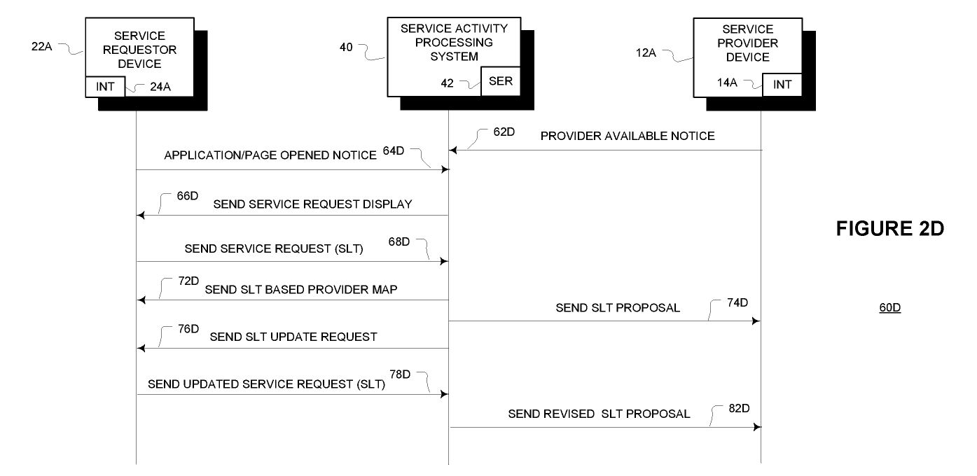

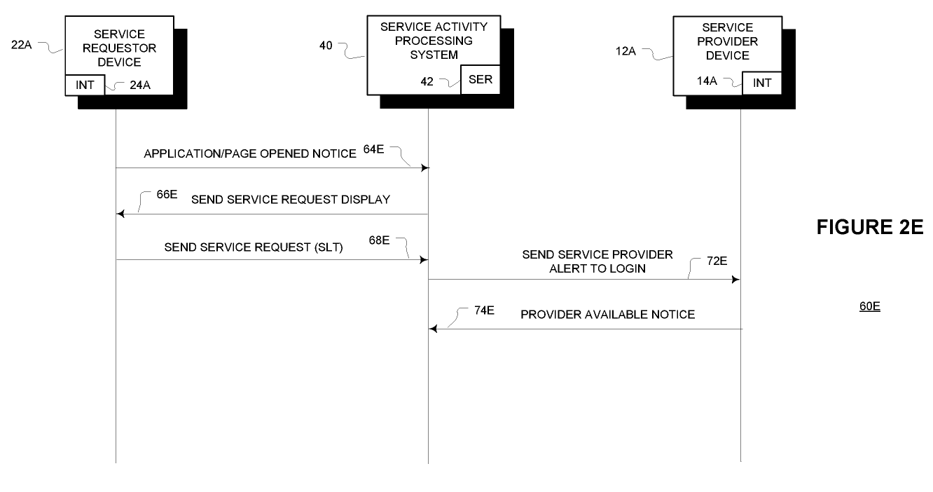

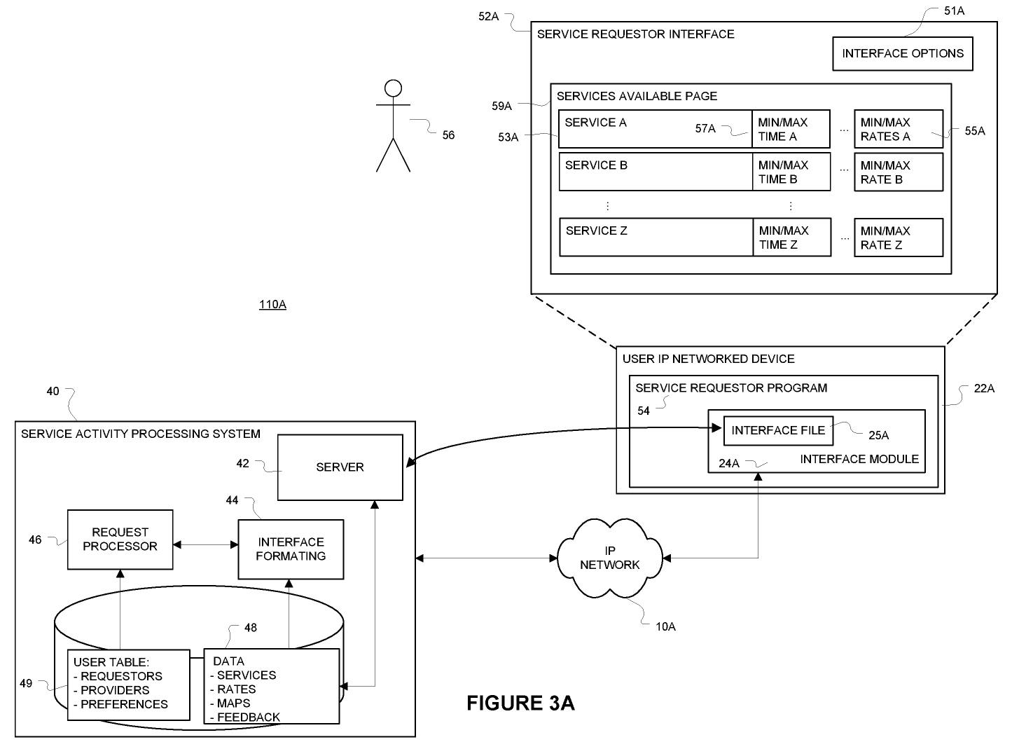

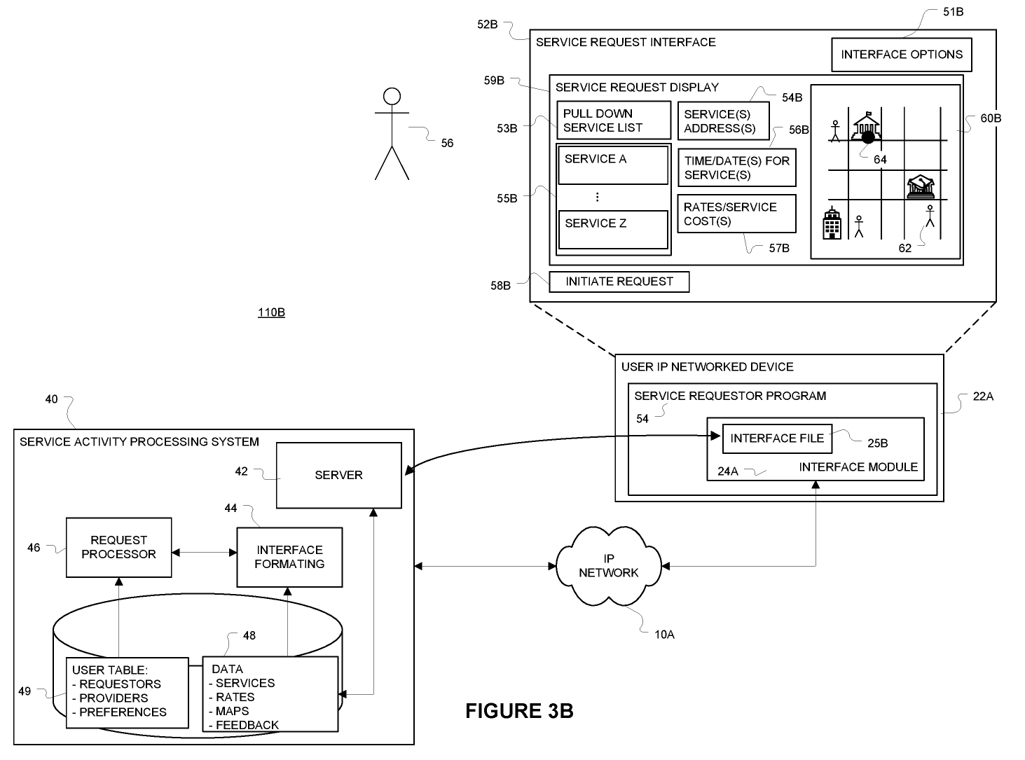

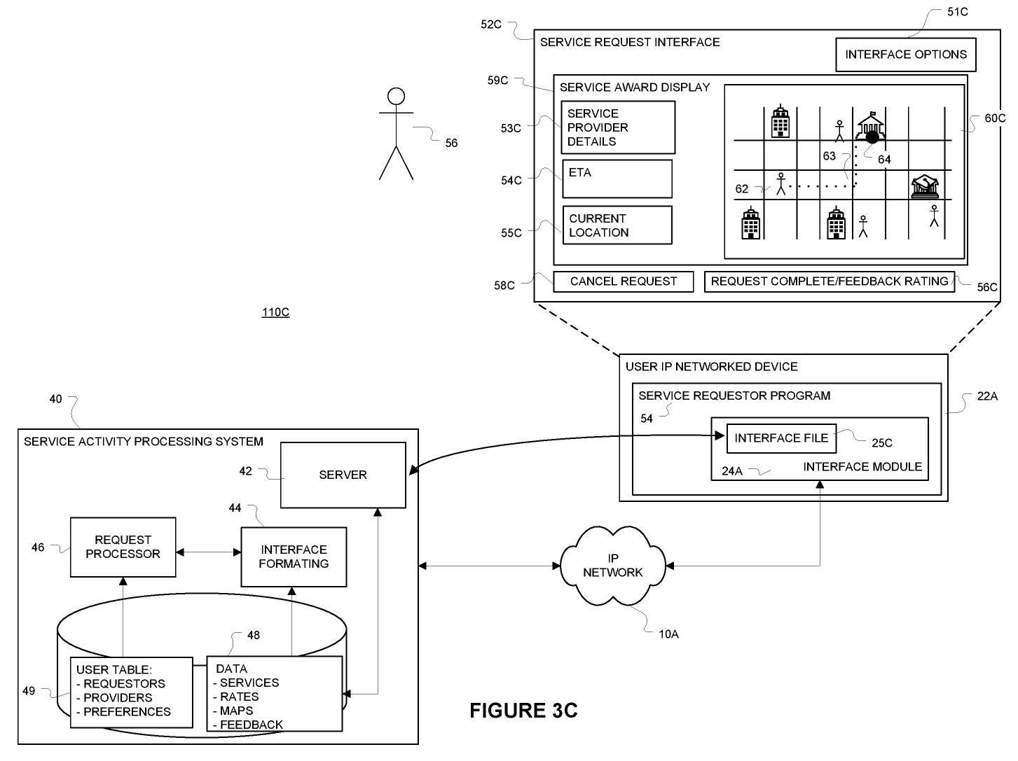

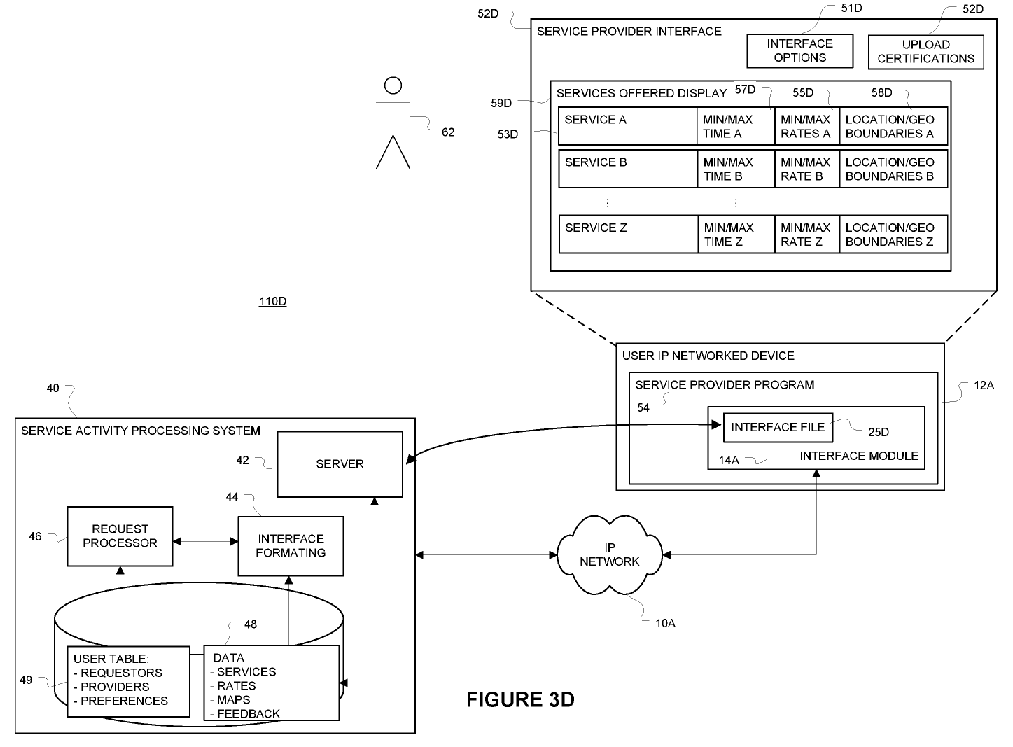

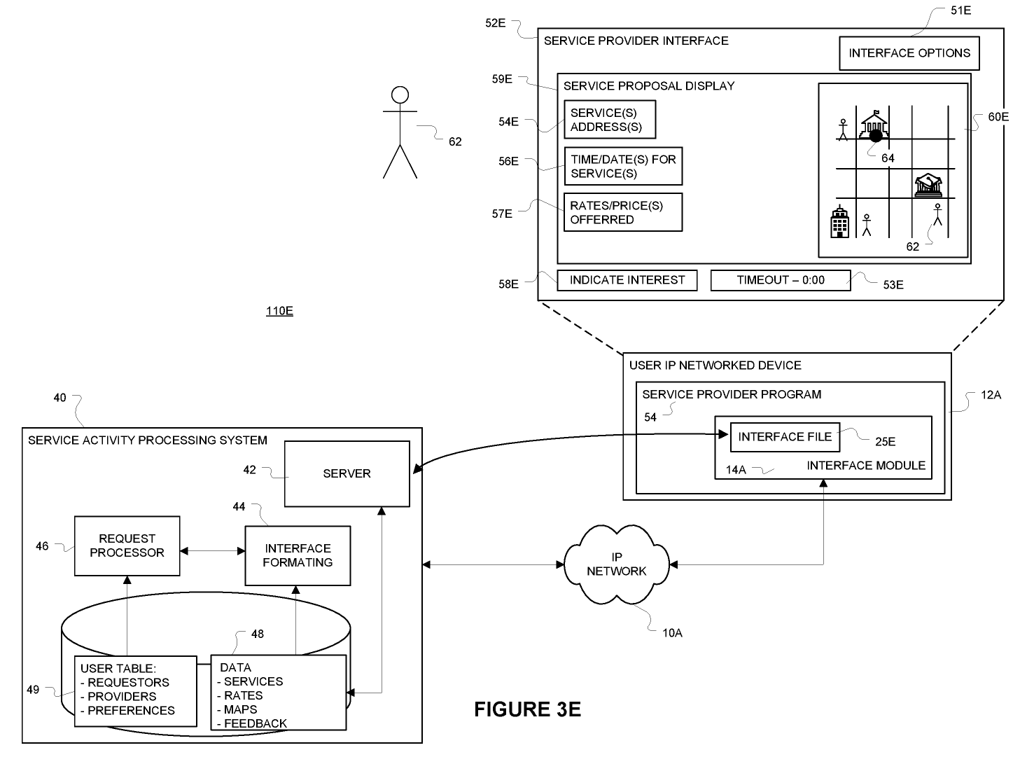

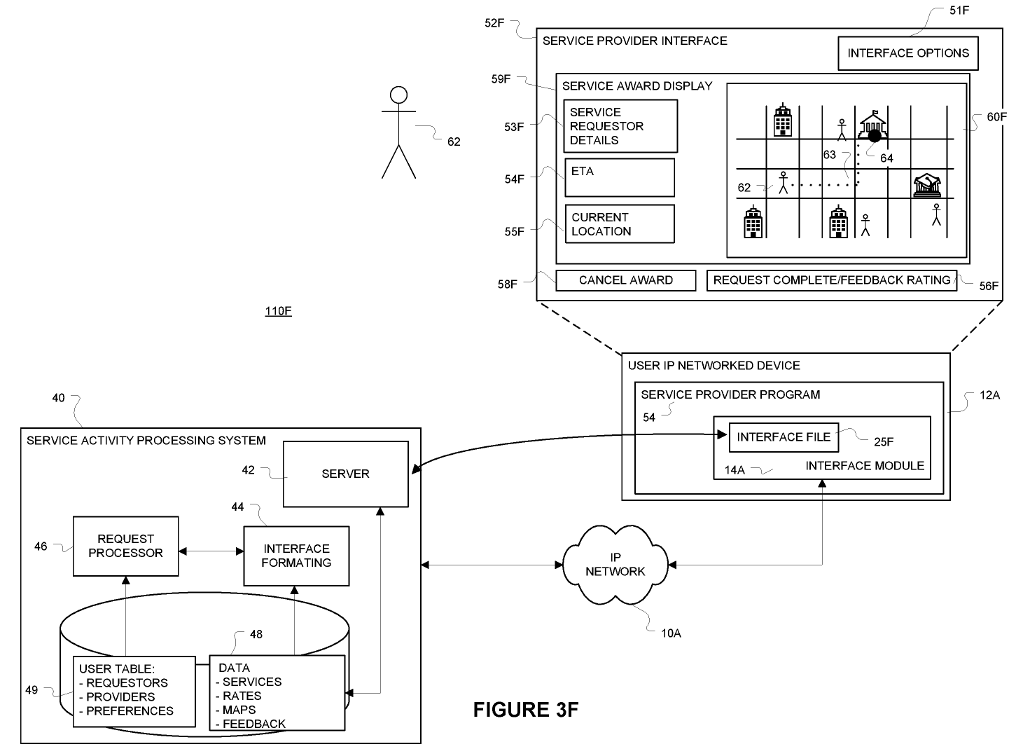

FIG. 2A is a diagram of communication between a first service requestor device (SRD) 22A and a service activity processing system (SAPS) 40 in a service request processing architecture 50 according to various embodiments. As shown in FIG. 2A, a service requestor 56 via a SRD 22A may request or be given a program or link to request initial access to the service request processing architecture 50 (communication 62A). In an embodiment, the SAPS 40 may forward an application for installation or real time execution, webpage, or other interface file 25A-C (FIGS. 3A-3C) to be executed by a server requestor program 54 operating on the SRD 22A. As noted, the server requestor program 54 may be a web browser, local application, or run-time application.

In an embodiment, a service requestor 56 via their SRD 22A may be forwarded terms and conditions (communication 64A) where the terms or conditions are displayed on the SRD 22A for review and acceptance in order to use or participate in the service request processing architecture 50. Once the service requestor 56 accepts the terms and conditions via their SRD 22A (communication 66A), they may be required to register with the SAPS 40 via a registration page or interface 25A (communication 68A) to ensure architecture 50 security. Once the service requestor 56 completes registration via their SRD 22A (communication 69A), they may be able to preselect services they may want to request via architecture 50 with the SAPS 40 via a services available display (59A of FIG. 3A) encoded in an interface file 25A (communication 72A). FIG. 3A is a block diagram of a service request processing system 110A showing a service activity processing system 40 communicating a services available display 59A to a service requestor device 22A according to various embodiments.

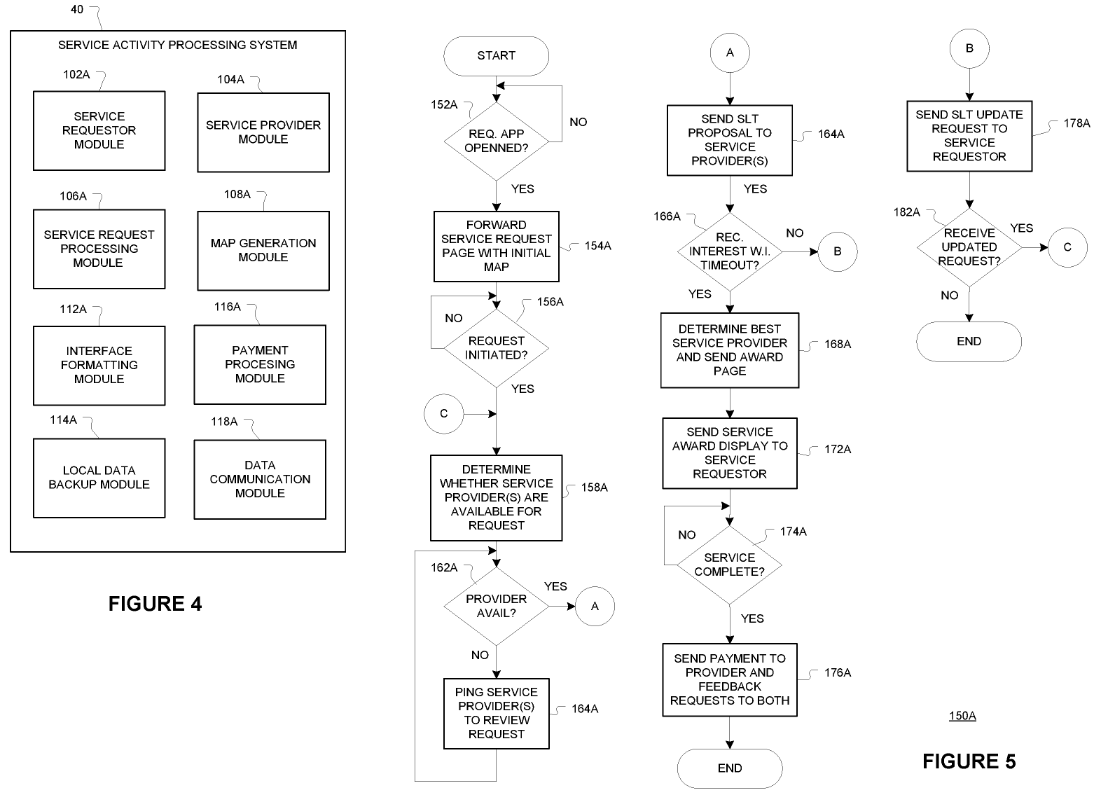

As shown in FIG. 3A, a SAPS 40 may include a server 42 (118A in FIG. 4), a request processor module 46 (106A in FIG. 4), interface formatting module 44 (112A in FIG. 4), a user table 49, and a database 48. The server 42 may communicate data between the SAPS 40 and SRD 22A-22C, SPD 12A-12C, and cloud server 16. The request processor 46 may process service requests, service request proposals, awards, completion notices, and other service related events as shown in FIGS. 2A-2D. The interface formatting module 44 may format communications to the SRD 22A-22C, SPD 12A-12C, and cloud server 16 based on the service requestor or service provider programs 54. The user table may store requestor 56 registrations and services selections, provider 62 registrations and services provided, preferences, and other related data. The database 48 may include services related messages (active and completed), rates and other related services information, maps related to service providers and requestors locations, and feedback data for service requestors 56 and providers 62.

FIG. 4 is a block diagram of a service activity processing system 40 according to various embodiments. As shown in FIG. 4, a SAPS 40 may include other modules in addition to those shown in FIGS. 3A-F. The additional modules may include a service requestor module 102A, a service provider module 104A, a map generation module 108A, a payment processing module 116A, and a local data backup module 114A. The service requestor module 102A may provide the primary communications between the SAPS 40 and a SRD 22A-22C including the service request display 59B and the service award display 59C shown in FIGS. 3B and 3C. The service provider module 104A may provide the primary communications between the SAPS 40 and a SPD 12A-12C including the service proposal display 59E and the service award display 59F shown in FIGS. 3E and 3F.

The map generation module 108A may generate the maps 60B, 60C, 60E, and 60F shown in FIGS. 3B, 3C, 3E, and 3F. The maps may include indications of the service location 64 (where the service is to be performed) and one or more service providers 62 along with a recommended direction of travel 63 (FIGS. 6C, 6F) for the service provider 62. The map generation module 108A may interact with online map providers such as Google®, MapQuest®, and others to generate a map 60B, 60C, 60E, and 60F. The payment processing module 116A may receive payments from service requestors 56 SRD 22A-22C or other systems once a service request 27 is complete or prior to its execution in an embodiment. The payment processing module 116A may also pay a service provider 62 SPD 12A-12C or via another system once a service request 27 is complete or prior to its execution in an embodiment. The payment processing system 116A may interact with various banking systems or online based payment system such as Paypal® to receive and send payments in an embodiment. The local data backup module 114A may communicate with a cloud storage provider or device 16 or other offline storage provider to backup and restore data 48.

As shown in FIG. 3A, a service requestors 56 services available display may include a list of various services 53A available in service request processing architecture 50, minimum and maximum times the service(s) may be engaged 57A, and minimum and maximum rates 55A for the services 53A where the rates 55A may vary based on times and services in an embodiment. A service requestor 56 may also be able to update selections and registration via the interface options 51A. In an embodiment, the service request processing architecture 50 may support many different services to be performed by a service provider at a particular time and location. In an embodiment, the service providers could be qualified or act as a court reporter. A service requestor may be a law firm or court that may need a court reporter to record a deposition, court proceeding, or other legal event. The court reporter may need to be qualified in certain jurisdictions and for certain type of recordings (video, stenography) and the service available page may enable a service requestor 56 to select a particular type of recording and jurisdiction that a court report is qualified to record or work.

In an embodiment, a service provider could be qualified or act as a substitute teacher. A service requestor may be an academic institution that may need a last minute substitute teacher due to an illness or other reason that a teacher is not available. The substitute teacher may need to be qualified to teach in general and for particular subject matter and the service available page may enable a service requestor 56 to select a particular subject matter that a substitute teacher is qualified to teach, e.g., a language, math, English, science, or other type of subject matter.

In an embodiment, a service provider could be a qualified medical professional such as a nurse, imaging technician, or physician. A service requestor may be an medical institution such a hospital, nursing home, or other location that provides medical services that may need a last minute medical professional due to an illness, medical emergency, or local emergency (weather event, natural disaster, accident, or other event requiring medical coverage). The medical professional may need to be qualified to perform or work in certain environments and the service available page may enable a service requestor 56 to select a particular environment or activity that a medical professional is qualified to perform or aid.

In an embodiment, a service provider could be qualified or act as a child care provider where the provider may need to be qualified to work with child of different ages, particular physical or mental conditions and comply with local, state, or federal regulations. In another embodiment, a service provider could be qualified or act as a construction worker where the provider may need to be qualified to work with certain equipment or trades and be regulated (local, state, or federal regulations including licensing boards). The service request processing architecture 50 could also be used for many other personal service events that require near term execution such as Flight attendants to cover flights or jet services, film industry professionals, massage professionals (call out services), and home repair professionals (plumber, electricians, and others) for emergency repairs,

Once a service requestor 56 via a SRD 22A completes the services available display (communication 74A), the SAPS 40 may store the requestor's 56 services selections and forward an application (local or runtime) or web link to be employed or executed by SRD 22A to create a service request (SLT) 27 (communication 68C of FIG. 2C). Similar to a service requestor 56 registering with service request processing architecture 50, a service provider 62 may also register with service request processing architecture 50 and provide the services they are qualified to perform. FIG. 2B is a diagram of communication between a first service provider device (SPD) 12A and a service activity processing system 40 in a service request processing architecture 50 according to various embodiments.

As shown in FIG. 2B, a service provider 62 via a SPD 12A may request or be given a program or link to request initial access to the service request processing architecture 50 (communication 62B) to be an authorized service provider. In an embodiment, the SAPS 40 may forward an application for installation or real time execution, webpage, or other interface file 25D-F (FIGS. 3D-3F) to be executed by a server requestor program 54 operating on the SPD 12A. As noted the server provider program 54 may be a web browser, local application, or run-time application.

In an embodiment, a service provider 62 via their SRD 12A may be forwarded terms and conditions (communication 64B) where the terms or conditions are displayed on the SPD 12A for review and acceptance in order to use or participate in the service request processing architecture 50 as a service provider. Once the service provider 62 accepts the terms and conditions via their SPD 12A (communication 66B), they may be required to register with the SAPS 40 via a registration page or interface 25D-F (communication 68B) to ensure architecture 50 security. Once the service provider 62 completes registration via their SPD 12A (communication 69B), they may be required to indicate services they are qualified to perform via architecture 50 with the SAPS 40 via a services offered display (59C of FIG. 3D) encoded in an interface file 25D (communication 72B). FIG. 3D is a block diagram of a service request processing system 110D showing a service activity processing system 40 communicating a services offered display 59D to a service provider device (SPD) 12A according to various embodiments.

As shown in FIG. 3D, a service providers 62 services offered display 59D may include a list of various services 53A “offerable” or a that a service provider may offer in service request processing architecture 50, minimum and maximum times the service(s) may be engaged 57A, minimum and maximum rates 55A for the services 53A where the rates 55A may vary based on times and services, and physical location(s) or geographical boundaries of where the provider will perform services 58D in an embodiment. A service provider 62 may also be able to update selections and registration via the interface options 51D. A service provider 62 may also be able to or required to upload certifications for each service they wish to offer via upload option 52D. In an embodiment, the SAPS 40 may store the certificates in the database 48 and provide them to a service requestor 56 when requested or with service awards.

Once service providers 62 and service requestors 56 are registered and have completed services offered and service available pages (FIGS. 3D and 3A), the SAPS 40 may employ the algorithm shown in FIG. 5 to process service requests. FIGS. 2C-2E are diagrams of communication between a first service requestor device 22A, a service activity processing system 40, and a first service provider device 12A in a service request processing architecture 50 according to various embodiments that may be employed during service request processing. FIGS. 3B and 3C are block diagrams of a service request processing system 110B, 110C showing a service activity processing system 40 communicating a service request display 59B and service award display 59C to a service requestor device 22A during the processing of service request 27 according to various embodiments. FIGS. 3E and 3F are block diagrams of service request processing systems 110E, 110F showing a service activity processing system 40 communicating a service proposal display 59E and service award display 59F to a service provider device 12A during the processing of service request 27 according to various embodiments.

In an embodiment, once a service requestor 56 via a SRD 22A opens a service request application, opens a service request base webpage, or related activity (activity 152A and communication 64C), the SAPS 40 may forward or cause an application to present a service request page 59B (FIG. 3B) with initial service provider map 60B as shown in FIG. 3B (activity 154A and communication 66C). As shown in FIG. 3B, a service request page 59B may include a map 60B showing the service provider's SRD 22A (if location is available) current location or registered location 64 and one or more service providers 62 that are available for certain services based on the service requestor's 56 previously completed services available display 59A. As shown in FIG. 3B, a service requestor 56 may be able to select one or more services 55B via a pull down list 53B or other list where the services 55B may be based on the on the service requestor's 56 previously completed services available display 59A or all available services 55B in an embodiment. A service requestor 56 may also be able to enter the service location or address(es) 54B (where the service(s) are to be performed), time and date for the requested service(s) 56B, and desired/accepted rates or costs for service(s) 57B and then select initiate request 58B to start a service request 27 (communication 68C and activity 156A).

In an embodiment, when a service provider 62 via a SPD 12A opens a service provider application, opens a service provider base webpage, or related activity, the SAPS 40 may forward or cause an application to forward the service offered display 59D (FIG. 3D) (communication 62C), a SAPS 40 may consider the provider 62 is available to perform the services at the times, rates, and locations (53D, 57D, 55D, 58D) recited on display 59D. Their SPD 12A may also provide the service provider's current location. In another embodiment, when a service provider 62 via a SPD 12A opens a service provider application, opens a service provider base webpage, or related activity, a SAPS 40 may consider the provider 62 available to perform the services at the times, rates, and locations (53D, 57D, 55D, 58D) recited on their last updated display 59D.

Based on the service request SLT 27 and active service provider's completed services offered display 59D, a SAPS 40 may determine whether one or more service providers 62 are available to perform the requested service SLT 27 (activity 162A). When one or more service providers are not available to perform the service request SLT 27, a SAPS 40 may ping registered service providers 62 via their SPD 12A to log in their provider application and/or update their service offered display 59D (communication 72E of FIG. 2E). In embodiment, a SAPS 40 may use a 3^{rd} party service to contact/ping a service provider including a short messaging service (SMS) provider or Email service. A service provider 62 as part of their registration may provider SMS contacts and email contacts. If no service provider becomes available after a predetermined time interval, SAPS 40 may request that the service requestor update their service request (SLT) (activity 178A and communication 76D of FIG. 2D). The updates may include increasing time to get to location to perform service or the rates offered to provide the service. The predetermined time interval may be related to the time when the service is to be performed, e.g., when the service is requested to be performed in X minutes, the time interval may a percentage of X, such as 5 to 25% (60 minutes for service to start, time out 3 to 15 minutes in an embodiment.)

Once a service requestor 56 has updated their request (activity 182A and communication 78D of FIG. 2D), SAPS 40 may then determine whether any providers 62 are available to perform the services (based on the service request 27 parameters SLT and the provider's offer display). If the service request 27 SLT fits one or more service providers parameters, a SAPS may send a SLT or service proposal display 59E or data to complete a service proposal display to the eligible service providers 62 via their 12A (activity 164A and communication 74C). In an embodiment, a SAPS 40 may also determine whether a provider can travel from their current reported location to the service location in time to perform the service. A SAPS 40 may use current traffic data or historical traffic data to determine whether a service provider 62 can commute to the service location in time to perform the service at the desired time.

FIG. 3E is a block diagram of a service request processing system 110E showing a service activity processing system 40 communicating a service proposal display 59E to a service provider device 12A according to various embodiments. As shown in FIG. 3E, a service proposal display 59E may include the service(s) to be performed along with address(es) 54E, the time/dates for the service(s) to be performed (56E), and the rates/price(s) offered for the service(s) 57E. The display 59E may also include a time out timer 53E showing how quickly a provider must respond to the proposal via the indicate interest option 58E. The time shown in the timeout window 53E may be based on the service provider's current location, the location(s) and time(s) of the service(s) to be performed, and historical or current traffic between the service provider's current location and the location(s) of the service(s) to be performed. The display 59E may also include a map 60E showing the provider's current location (via their SPD 12A or other device) and the service(s) location(s). A service provider 62 may indicate they would like to be considered for performing the proposed services 54E via the indicate interest window 58E (communication 76C).

In an embodiment, the SAPS 40 may award the project to perform the SLT request 27 to the first qualified service provider 62 that accepts the service requestor's terms as presented in the SLT proposal (communication 74C and service proposal display 59E). In another embodiment, when a service provider 62 sends a SLT proposal interest (communication 76C via service proposal display 59E), the SLT proposal may include the service provider's 62 offered rate(s) to perform the SLT request 27. In such an embodiment, a service provider 62 may be able to set their desired or acceptable compensation to perform the SLT 27. Another service provider 62 may also set their desired or acceptable compensation to perform the SLT 27. A SAPS 40 may award the project to perform the SLT 27 to the qualified service provider 62 that offers the lowest cost in a certain time interval, creating an effective reverse auction.

If no interest communications 76C have been received with the predetermined time interval, a SAPS 40 may direct a service requestor to modify their request (activity 178A). Otherwise, when one or more service providers 62 have sent interest communications 76C via their SPD 12A, a SAPS 40 may determine the best service provider of the group (may be the only one is the best) and send an award display or data to complete an award page to the service provider (activity 168A and communication 78C). A SAPS 40 may also send an award display or data to complete an award page to a service requestor (activity 172A and communication 82C). In an embodiment, a SAPS 40 may determine the best provider 62 based on their feedback, ability to get to location on time, and their response to the proposal (order of when interest communications 76C were received). A SAPS 40 may send a notice to non-selected service providers 12A so they may consider or show interest in other proposals. In an embodiment, the service proposal display 59D may remain active on a service provider's SPD 12A until the service request is awarded to a service provider.

FIG. 3C is a block diagram of a service request processing system 110C showing a service activity processing system 40 communicating a service award display 59C to a service requestor device 22A according to various embodiments. FIG. 3F is a block diagram of a service request processing system 110F showing a service activity processing system 40 communicating a service award display 59F to a service provider device 12A according to various embodiments. As shown in FIGS. 3C and 3F, service award displays 110C and 110F may be similar and include the service provider or requestor details (53C and 53F), providers ETA (estimated time of arrival) 54C, and service providers current location 55C. The displays 59C, 59F may also include a real time map 60C, 60F that shows the service location 64, the service provider's current location 62, and an ideal direction of travel 63. The map 60C, 60F, ETA 54C, and current location 55C may be updated in real time as the service provider 62 commutes to the service location 64.

In an embodiment, either party may cancel the service request via window 58C, 58F. In a further embodiment, each party may indicate when the service request is complete and provide a feedback rating via window 56C, 56F (communications 86C, 92C, 98C) (activity 174A). Once the request 27 have been reported complete (activity 174A), a SAPS 40 may send payment to the service provider 62 as described and provide notice of same (activity 176A and communication 88C). A SAPS 40 may also request either party to provide feedback and record/store feedback when received (activity 176A and communication 92C, 94C, 96C, and 98C). The feedback rating may include moveable bars or selectable number of stars for various attributes related to the performance of the SLT request 27 including timeliness, professional appearance, environment, quality of service. The feedback from a service provider 62 (communication 94C) or from a service requestor 56 (communication 98C) may include personal comments.

FIG. 6A illustrates a block diagram of a device 230 that may be employed as a SAPS 40 in various embodiments. The device 230 may include a central processing unit (CPU) 232, a random access memory (RAM) 234, a read only memory (ROM) 236, a storage unit 238, a modem/transceiver 244, and an antenna 246. The CPU 232 may include a server module 252 and an interface logic/interface formatting module 254 (modules 44 in FIGS. 3A-F and 112A of FIG. 4). The RAM 234 may include a queue or table 248 where the queue 248 may be used to store the user table 49 and data 48 including active service requests. The storage 238 may also include a queue or database 256 where the queue 256 may be used to store the user table 49 and data 48. The storage 238 may be local or coupled to the device 230 via one or more networks 10A, 10B, 30 including the cloud storage 16. The server/search engine module 252 and the interface logic/interface formatting module 254 may be separate elements.

The modem/transceiver 244 may couple, in a well-known manner, the device 230 to the IP networks 10A, 10B and cellular network 30 to enable communication with the devices 12A-12C, 16, and 22A-22C. In an embodiment, the modem/transceiver 244 may be a wireless modem or other communication device that may enable communication with the devices 112A-12C, 16, and 22A-22C. The CPU 232 via the server module 252 may direct communication between modem 244 and a device 12A-12C, 16, and 22A-22C.

The ROM 236 may store program instructions to be executed by the CPU 232, interface logic/interface formatting module 254, or server module 252. The RAM 234 may be used to store temporary program information, queues, databases, and overhead information. The storage device 238 may comprise any convenient form of data storage and may be used to store temporary program information, queues, databases, and overhead information.

A device 260 is shown in FIG. 6B that may be used in various embodiments as a device 12A-12C, 16, and 22A-22C. The device 260 may include a central processing unit (CPU) 262, a random access memory (RAM) 264, a read only memory (ROM”) 266, a display 268, a user input device 272, a transceiver application specific integrated circuit (ASIC) 274, a microphone 288, a speaker 282, and an antenna 284. The CPU 262 may include an interface module 292. The RAM 264 may include a queue 278 where the queue 278 may store service request related data. The interface module 292 may process interface files 25A-F from and generate data requests for the SAPS 40.

The ROM 266 is coupled to the CPU 262 and may store the program instructions to be executed by the CPU 262, the User 56 DCMP 54, and the interface module 292. The RAM 264 is coupled to the CPU 262 and may store temporary program data, overhead information, and the queues 278. The user input device 272 may comprise an input device such as a keypad, touch pad screen, track ball or other similar input device that allows the user to navigate through menus in order to operate the device 260. The display 268 may be an output device such as a CRT, LCD or other similar screen display that enables the user to read, view, or hear received data from the SAPS 40.

The microphone 288 and speaker 282 may be incorporated into the device 260. The microphone 288 and speaker 282 may also be separated from the device 260. Received data may be transmitted to the CPU 262 via a serial bus 276 where the data may include interface files 25A-F, or protocol information. The transceiver ASIC 274 may include an instruction set necessary to communicate data in architecture 50, 110A-F. The ASIC 274 may be coupled to the antenna 284 to communicate wireless messages, interface files 25A-F, and other communications within the architecture 50, 110A-F. When a message is received by the transceiver ASIC 274, its corresponding data may be transferred to the CPU 262 via the serial bus 276. The data can include wireless protocol, overhead information, interface files 25A, and other communications to be processed by the device 260 in accordance with the methods described herein.

Any of the components previously described can be implemented in a number of ways, including embodiments in software. Any of the components previously described can be implemented in a number of ways, including embodiments in software. Thus, the CPU 232, an interface logic/interface formatting module 254, server module 252, modem/transceiver 244, antenna 246, storage 238, RAM 234, ROM 236, queue 248, queue 256, CPU 262, interface 292, transceiver ASIC 274, antenna 284, microphone 288, speaker 282, ROM 266, RAM 264, queue 278, user input 272, display 268, may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A method for processing service requests including:
receiving an available notification from a service provider electronic device indicating that a service provider is available;
receiving a service request from a service requestor electronic device, the service request including the type of service to be performed and the time when and the location where the requested service is to be performed;
sending a service proposal to at least one service provider electronic device, the service proposal including type of service to be performed and the time when and the location where the requested service is to be performed;
receiving a service proposal interest notification from service provider electronic device indicating that a service provider wants to perform the requested service;
sending a service award notification to a service provider electronic device that sent a service proposal interest notification for the service request.

2. The method for processing service requests of claim 1, including receiving a notification from a service provider electronic device when one of a service provider application and webpage is displayed on the service provider electronic device.

3. The method for processing service requests of claim 1, wherein the notification from a service provider electronic device includes the service provider electronic device's current location.

4. The method for processing service requests of claim 3, including determining when at least one service provider is available to perform the service request based on the service provider electronic device's current location and the time when and the location where the requested service is to be performed and sending a service proposal to the at least service provider's electronic device, the service proposal including type of service to be performed and the time when and the location where the requested service is to be performed.

5. The method for processing service requests of claim 1, wherein the available notification from a service provider electronic device includes the service provider electronic device's current location.

6. The method for processing service requests of claim 5, when a service proposal interest notification is received from two or more service provider electronic devices for a single service request, sending a service award notification to one of the two or more service provider electronic devices that sent a service proposal interest notification based on the two or more service provider electronic device's current locations and the time when and the location where the requested service is to be performed.

7. The method for processing service requests of claim 1, wherein the requested service is a personal service to be performed at the location.

8. The method for processing service requests of claim 1, wherein the service request includes the type of service to be performed, the compensation, and the time when and the location where the requested service is to be performed and the service proposal further includes an indication of the compensation.

9. The method for processing service requests of claim 1, further including sending a service award notification to the service requestor electronic device including the awarded service provider.

10. The method for processing service requests of claim 5, further including sending a service award notification to the service requestor electronic device including the awarded service provider and indication of the awarded service provider's location based service provider electronic device's current location.

11. The method for processing service requests of claim 10, further including receiving updated service provider electronic device's current location periodically.

12. The method for processing service requests of claim 11, further including periodically sending service provider's current location information to the service requestor electronic device after receiving updated location information from the service provider electronic device.

13. The method for processing service requests of claim 1, further including:
sending a list of available services that the service requestor may request to a service requestor electronic device for display on the service requestor electronic device; and
receiving a list of selected available services that the service requestor may request from a service requestor electronic device based on the forwarded list of available services displayed on the service requestor electronic device.

14. The method for processing service requests of claim 13, further including sending a service request display to a service requestor electronic device for display on the service requestor electronic device, the service request display based on the service requestor's received list of available services.

15. The method for processing service requests of claim 1, further including:
sending a list of offered services that the service provider may indicate that they are qualified to provide to a service provider electronic device for display on the service provider electronic device; and
receiving a list of selected available services that the service requestor may request from a service requestor electronic device based on the forwarded list of available services displayed on the service requestor electronic device.

16. The method for processing service requests of claim 15, further including receiving a completed list of offered services from a service provider electronic device.

17. The method for processing service requests of claim 16, further including sending a service proposal to at least one service provider electronic device based on the type of service to be performed and service provider's received completed list of offered services.

18. The method for processing service requests of claim 17, further including receiving an uploaded certification document for at least one of the completed list of offered services from a service provider electronic device.

19. The method for processing service requests of claim 18, further including sending a service award notification to the service requestor electronic device including the awarded service provider and a certification document associated with type of service to be performed for the service request.

20. The method for processing service requests of claim 4, further including sending a message to at least one service provider electronic device that has not send an available notification when it is determined that at least one service provider is not available to perform the service request based on the service provider electronic device's current location and the time when and the location where the requested service is to be performed.
